(19) United States
(12) Patent Application Publication
(10) Pub. No.: US 2015/0081493 A1
(43) Pub. Date: Mar. 19, 2015

(54) SELF-SERVICE GUARANTEED FINANCIAL INSTRUMENTS

(71) Applicant: Bank of America Corporation, Charlotte, NC (US)

(72) Inventor: Tyler R. Johnson, Tega Cay, SC (US)

(73) Assignee: Bank of America Corporation, Charlotte, NC (US)

(21) Appl. No.: 14/028,112

(22) Filed: Sep. 16, 2013

(51) Int. Cl. G06Q 20/04; G06Q 20/10

(52) U.S. Cl. CPC G06Q 20/042; G06Q 20/108; G06Q 20/1085
USPC 705/35

(57) ABSTRACT

A request for a financial instrument guaranteed by a financial institution may be received from a user device. A record may be created for the request, and the record may be stored in a database comprising a plurality of records for requests for financial instruments guaranteed by the financial institution. Search criteria specifying one or more aspects of the record for the request for the financial instrument guaranteed by the financial institution may be received from a computing device associated with the financial institution. The search criteria may be utilized to identify, from amongst the plurality of records for requests for financial instruments guaranteed by the financial institution, the record for the request for the financial instrument guaranteed by the financial institution. Information stored in the record may be communicated to the computing device associated with the financial institution.

### BACKGROUND

Consumers of products and services are increasingly turning to self-service options. Particularly in the financial context, self-service options are frequently advantageous for the consumer, and often for the servicing financial institution as well. Self-service options typically provide an efficient solution for providing consumers with products or services, while freeing up human resources that would otherwise be utilized providing the products or services to perform tasks better suited to their irreplaceable skills (e.g., product or service counseling, support, or the like). Additionally, in the financial context, self-service options may provide increased security by reducing the exposure of confidential information. Accordingly, a need exists for self-service guaranteed financial instruments.

### SUMMARY

The following presents a simplified summary in order to provide a basic understanding of some aspects of the disclosure. This summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In accordance with one or more embodiments, a request for a financial instrument guaranteed by a financial institution may be received from a user device. A record may be created for the request for the financial instrument guaranteed by the financial institution. The record for the request for the financial instrument guaranteed by the financial institution may be stored in a database comprising a plurality of records for requests for financial instruments guaranteed by the financial institution. Search criteria specifying one or more aspects of the record for the request for the financial instrument guaranteed by the financial institution may be received from a computing device associated with the financial institution. The search criteria specifying one or more aspects of the record for the request for the financial instrument guaranteed by the financial institution may be utilized to identify, from amongst the plurality of records for requests for financial instruments guaranteed by the financial institution, the record for the request for the financial instrument guaranteed by the financial institution. Information stored in the record for the request for the financial instrument guaranteed by the financial institution may be communicated to the computing device associated with the financial institution.

In some embodiments, the financial instrument guaranteed by the financial institution may be a cashier's check, a banker's check, a certified check, and/or an official check.

In some embodiments, the request for the financial instrument guaranteed by the financial institution may include information for identifying a branch location affiliated with the financial institution for picking up the financial instrument guaranteed by the financial institution. The search criteria specifying one or more aspects of the record for the request for the financial instrument guaranteed by the financial institution may include at least a portion of the information for identifying a branch location affiliated with the financial institution for picking up the financial instrument guaranteed by the financial institution.

In some embodiments, at least one record of the plurality of records for requests for financial instruments guaranteed by the financial institution may indicate one or more funding sources for a request for a financial instrument guaranteed by the financial institution corresponding to the at least one record. Information identifying one or more funding sources for the request for the financial instrument guaranteed by the financial institution may be received. The one or more funding sources for the request for the financial instrument guaranteed by the financial institution may be identified in the record for the request for the financial instrument guaranteed by the financial institution. The one or more funding sources for the request for the financial instrument guaranteed by the financial institution may include funds deposited with the financial institution, a wire transfer to the financial institution, and/or a cash deposit with the financial institution.

In some embodiments, the request for the financial instrument guaranteed by the financial institution may include information indicating a payee for the financial instrument guaranteed by the financial institution and a payment amount for the financial instrument guaranteed by the financial institution. The user device may be a personal computing device executing a web browser application that presents a website associated with the financial institution. The information indicating the payee for the financial instrument guaranteed by the financial institution and the payment amount for the financial instrument guaranteed by the financial institution may be received via a webserver hosting the website associated with the financial institution. Additionally or alternatively, the user device may be a mobile device executing a mobile device application associated with the financial institution. The information indicating the payee for the financial instrument guaranteed by the financial institution and the payment amount for the financial instrument guaranteed by the financial institution may be received via a server in communication with the mobile device executing the mobile device application associated with the financial institution.

In some embodiments, the user device may be an automated teller machine (ATM). The information indicating the payee for the financial instrument guaranteed by the financial institution and the payment amount for the financial instrument guaranteed by the financial institution may be received via a server in communication with the ATM. A portion of the information indicating the payee for the financial instrument guaranteed by the financial institution and the payment amount for the financial instrument guaranteed by the financial institution may be input, via the ATM, by an individual requesting the financial instrument guaranteed by the financial institution. Additionally or alternatively, a portion of the information indicating the payee for the financial instrument guaranteed by the financial institution and the payment amount for the financial instrument guaranteed by the financial institution may be input by an associate of the financial institution communicating, via the ATM, with an individual requesting the financial instrument guaranteed by the financial institution. A portion of the information indicating the payee for the financial instrument guaranteed by the financial institution and the payment amount for the financial instrument guaranteed by the financial institution may be verified, via the ATM, by the individual requesting the financial instrument guaranteed by the financial institution. In some embodiments, a portion of the information indicating the payee for the financial instrument guaranteed by the financial institution and the payment amount for the financial instrument guaranteed by the financial institution may be communicated to the associate of the financial institution by the individual requesting the financial instrument guaranteed by the financial institution via a video conference session supported by the ATM.

In some embodiments, the request for the financial instrument guaranteed by the financial institution may include information indicating a purpose for the financial instrument guaranteed by the financial institution. The information indicating the purpose for the financial instrument guaranteed by the financial institution may be utilized to determine at least one of a payee for the financial instrument guaranteed by the financial institution or a payment amount for the financial instrument guaranteed by the financial institution. The information indicating the purpose for the financial instrument guaranteed by the financial institution may indicate that the purpose for the financial instrument guaranteed by the financial institution is to close an account of the financial institution. The payment amount for the financial instrument guaranteed by the financial institution may be determined based on a current balance of the account of the financial institution. Additionally or alternatively, the information indicating the purpose for the financial instrument guaranteed by the financial institution may indicate that the purpose for the financial instrument guaranteed by the financial institution is to pay a debt obligation owed to a lending entity associated with the financial institution. The payee for the financial instrument guaranteed by the financial institution may be determined to be the lending entity associated with the financial institution. The payment amount for the financial instrument guaranteed by the financial institution may be determined to be an amount associated with the debt obligation owed to the lending entity associated with the financial institution. Additionally or alternatively, the information indicating the purpose for the financial instrument guaranteed by the financial institution may indicate that the purpose for the financial instrument guaranteed by the financial institution is to exchange a non-guaranteed financial instrument associated with the financial institution for the financial instrument guaranteed by the financial institution. The payee for the financial instrument guaranteed by the financial institution may be determined to be a payee indicated by the non-guaranteed financial instrument associated with the financial institution. The payment amount for the financial instrument guaranteed by the financial institution may be determined to be an amount specified by the non-guaranteed financial instrument associated with the financial institution.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for providing self-service guaranteed financial instruments in accordance with one or more example embodiments;

FIGS. 4A, 4B, 4C, and 4D depict an illustrative event sequence for providing self-service guaranteed financial instruments in accordance with one or more example embodiments; and

FIG. 5 depicts an illustrative method for providing self-service guaranteed financial instruments in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

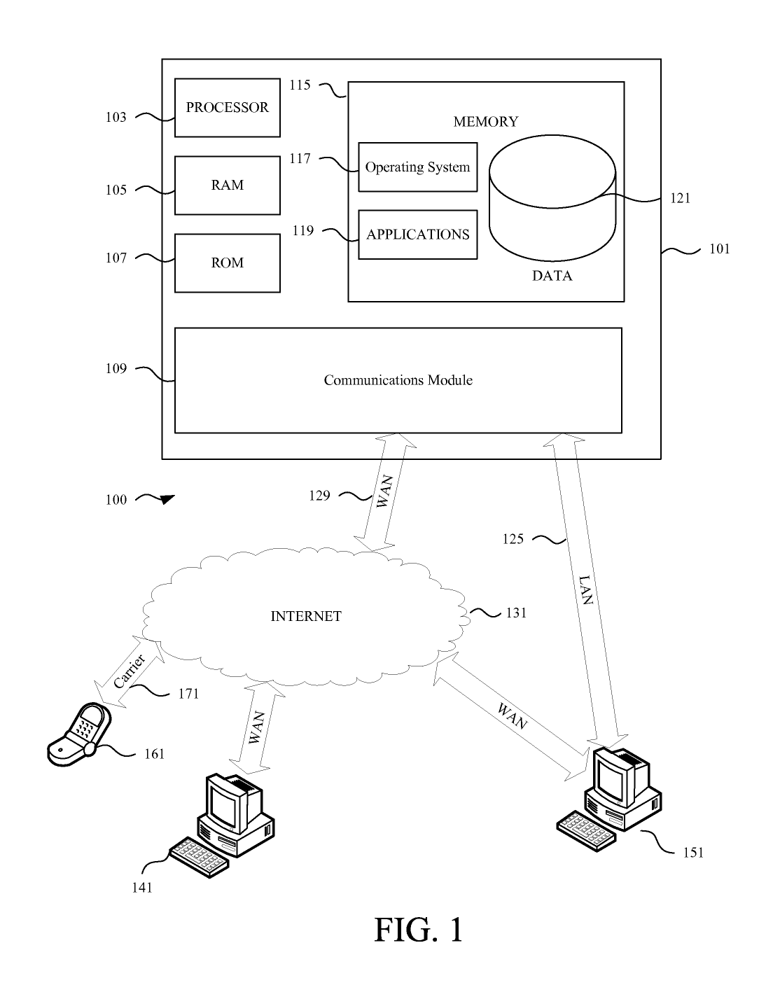

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

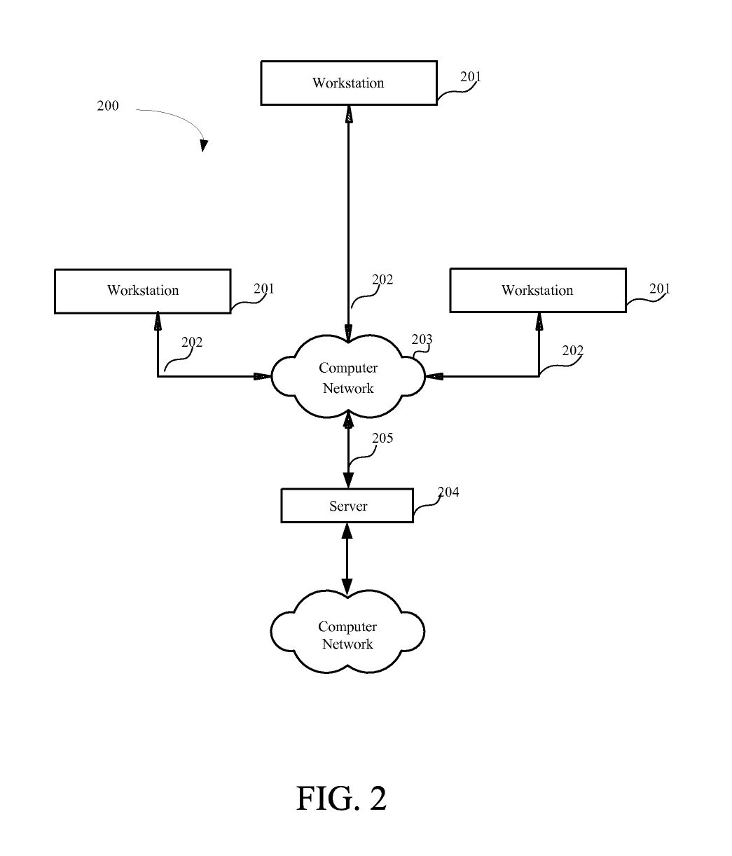

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

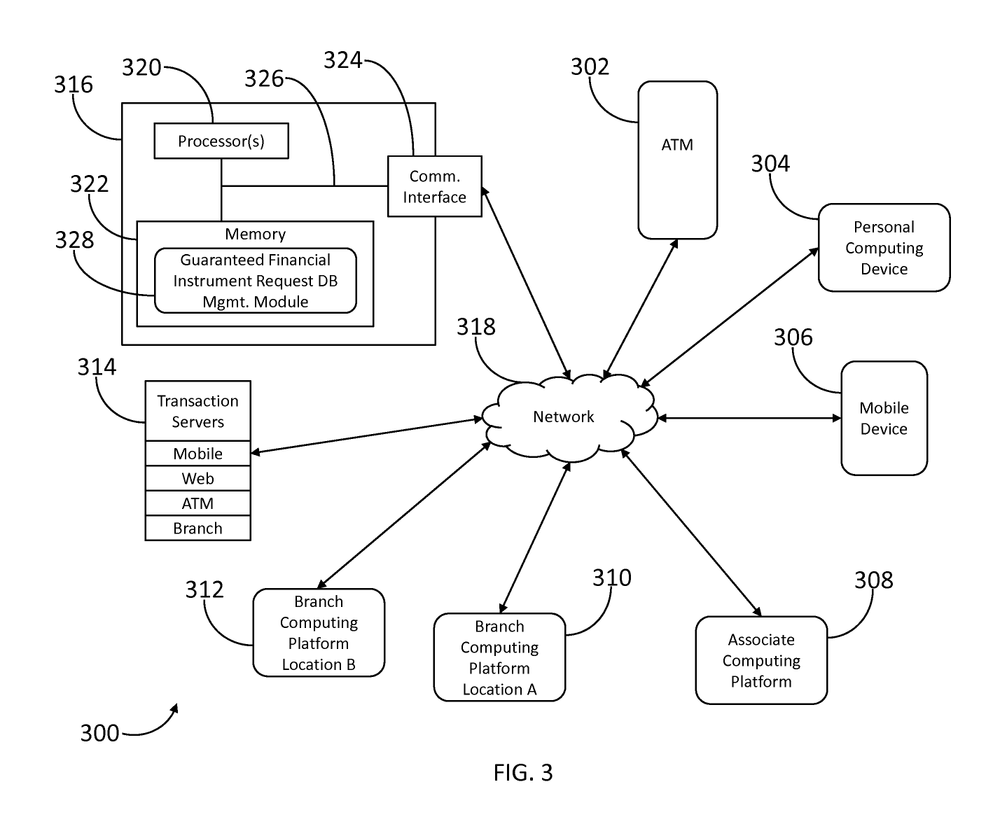

FIG. 3 depicts an illustrative computing environment for providing self-service guaranteed financial instruments in accordance with one or more example embodiments. Referring to FIG. 3, computing environment 300 may include one or more computing platforms. For example, computing environment 300 may include ATM 302, personal computing device 304, mobile device 306, associate computing platform 308, branch computing platform 310, branch computing platform 312, transaction servers 314, and computing platform 316. ATM 302 may be a computing platform configured to perform one or more financial transactions (e.g., withdrawals, deposits, or the like). As will be described in greater detail below, in some embodiments, ATM 302 may be configured to support an audio/visual conference session between an individual utilizing ATM 302 and an associate of a financial institution associated with ATM 302. Personal computing device 304 may be any type of computing device capable of providing an individual with an interface for performing a financial transaction with a financial institution (e.g., a desktop computer, laptop computer, or the like). For example, personal computing device 304 may be a desktop computer executing a web browser application that presents a website associated with the financial institution for performing one or more financial transactions with the financial institution. Mobile device 306 may be any type of portable computing device capable of providing an individual with an interface for performing a financial transaction with a financial institution (e.g., a mobile phone, smartphone, personal digital assistant (PDA), personal media device, tablet computer, or the like). For example, mobile device 306 may be a smartphone executing an application associated with a financial institution for performing one or more financial transactions with the financial institution.

Associate computing platform 308, branch computing platform 310, and branch computing platform 312 may be any type of computing platform configured to perform and/or assist an individual in performing a financial transaction with a financial institution. For example, associate computing platform 308 may be a desktop computer executing an application for performing a financial transaction with a financial institution and/or for assisting an individual in performing a financial transaction with a financial institution. As will be described in greater detail below, in some embodiments, associate computing platform 308 may be configured to support an audio/visual conference session between an associate of a financial institution utilizing associate computing platform 308 and an individual utilizing ATM 302, personal computing device 304, and/or mobile device 306. For example, associate computing platform 308 may be configured to support an audio/visual conference session between an associate of a financial institution utilizing associate computing platform 308 and an individual utilizing ATM 302. Branch computing platforms 310 and 312 may include one or more computing devices configured to perform and/or assist an individual in performing a financial transaction with a financial institution. For example branch computing platforms 310 and 312 may include one or more computing devices (e.g., desktop computers, laptop computers, terminals) utilized by associates of a financial institution working at a particular branch of a financial institution to perform and/or assist an individual in performing a financial transaction with a financial institution (e.g., a deposit, funds transfer, withdrawal, or the like). Branch computing platform 310 may include one or more computing devices associated with a branch located at a particular geographic location (e.g., location A), and branch computing platform 312 may include one or more computing devices associated with a branch located at a different geographic location (e.g., location B).

Transaction servers 314 may include one or more computing devices (e.g., mainframes, servers, blades, or the like) configured to manage and maintain records associated with a financial institution and/or its customers. Transaction servers 314 may also include one or more computing devices configured to interface the financial institution or one or more computing devices associated with the financial institution (e.g., one or more of transaction servers 314, branch computing platform 310, branch computing platform 312, and/or associate computing platform 308) with customers or individuals desiring to perform one or more financial transactions associated with the financial institution, and/or one or more computing platforms utilized by a customer or individual desiring to perform one or more financial transactions associated with the financial institution (e.g., ATM 302, personal computing device 304, and/or mobile device 306). Network 318 may interconnect one or more of ATM 302, personal computing device 304, mobile device 306, associate computing platform 308, branch computing platform 310, branch computing platform 312, transaction servers 314, and/or computing platform 316. Network 318 may include one or more sub-networks (e.g., LANs, WANs, or the like).

Computing platform 316 may include one or more processor(s) 320, memory 322, communication interface 324, and data bus 326. Data bus 326 may interconnect processor(s) 320, memory 322, and/or communication interface 324. Communication interface 324 may be a network interface configured to support communication between computing platform 316 and network 318, or one or more sub-networks thereof. Memory 322 may include one or more program modules comprising instructions that when executed by processor(s) 320 cause computing platform 316 to perform one or more functions described herein. For example, memory 322 may include guaranteed financial instrument request database management module 328. Guaranteed financial instrument request database management module 328 may comprise instructions that when executed by processor(s) 320 cause computing platform 316 to receive a request for a financial instrument guaranteed by a financial institution from a user device (e.g., ATM 302, personal computing device 304, and/or mobile device 306).

The instructions may also cause computing platform 316 to create a record for the request for the financial instrument guaranteed by the financial institution, and store the record for the request for the financial instrument guaranteed by the financial institution in a database comprising a plurality of records for requests for financial instruments guaranteed by the financial institution. The instructions may further cause computing platform 316 to receive search criteria specifying one or more aspects of the record for the request for the financial instrument guaranteed by the financial institution from a computing device associated with the financial institution (e.g., branch computing platform 310 or 312), and utilize the search criteria specifying one or more aspects of the record for the request for the financial instrument guaranteed by the financial institution to identify, from amongst the plurality of records for requests for financial instruments guaranteed by the financial institution, the record for the request for the financial instrument guaranteed by the financial institution. The instructions may further cause computing platform 316 to communicate information stored in the record for the request for the financial instrument guaranteed by the financial institution to the computing device associated with the financial institution.

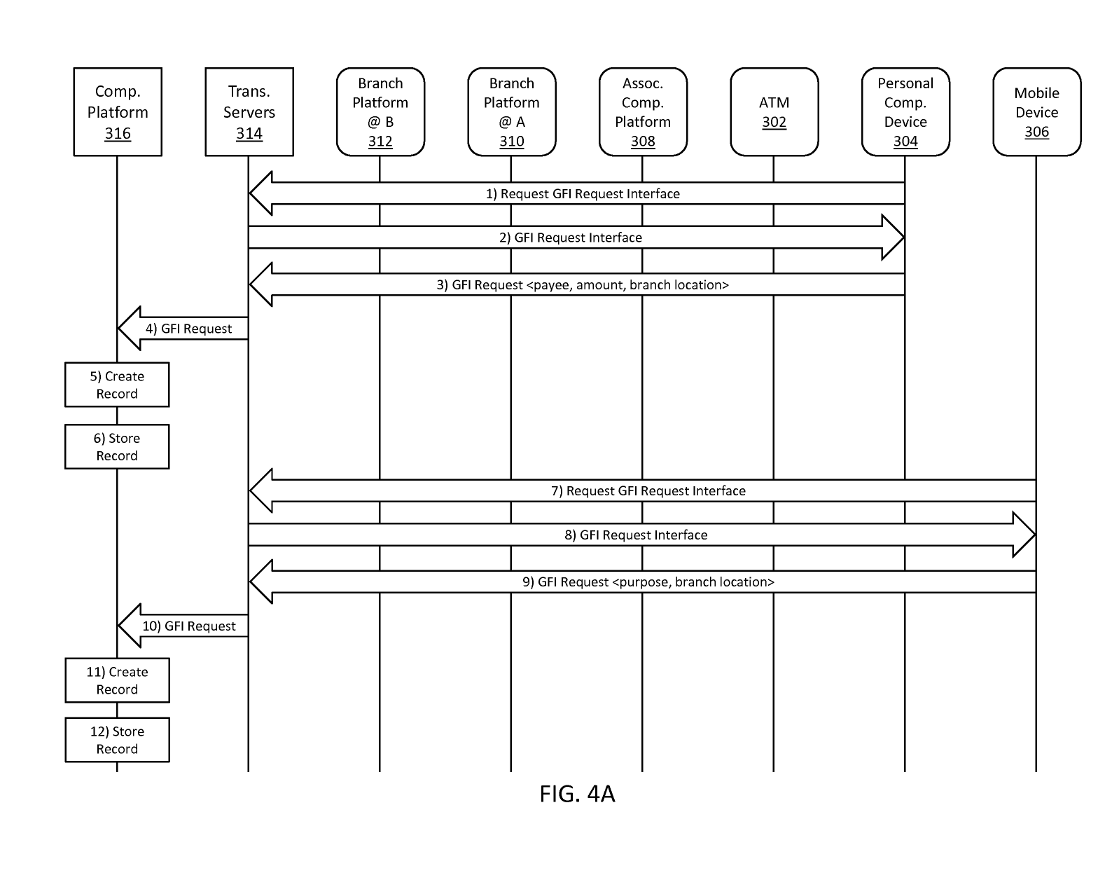

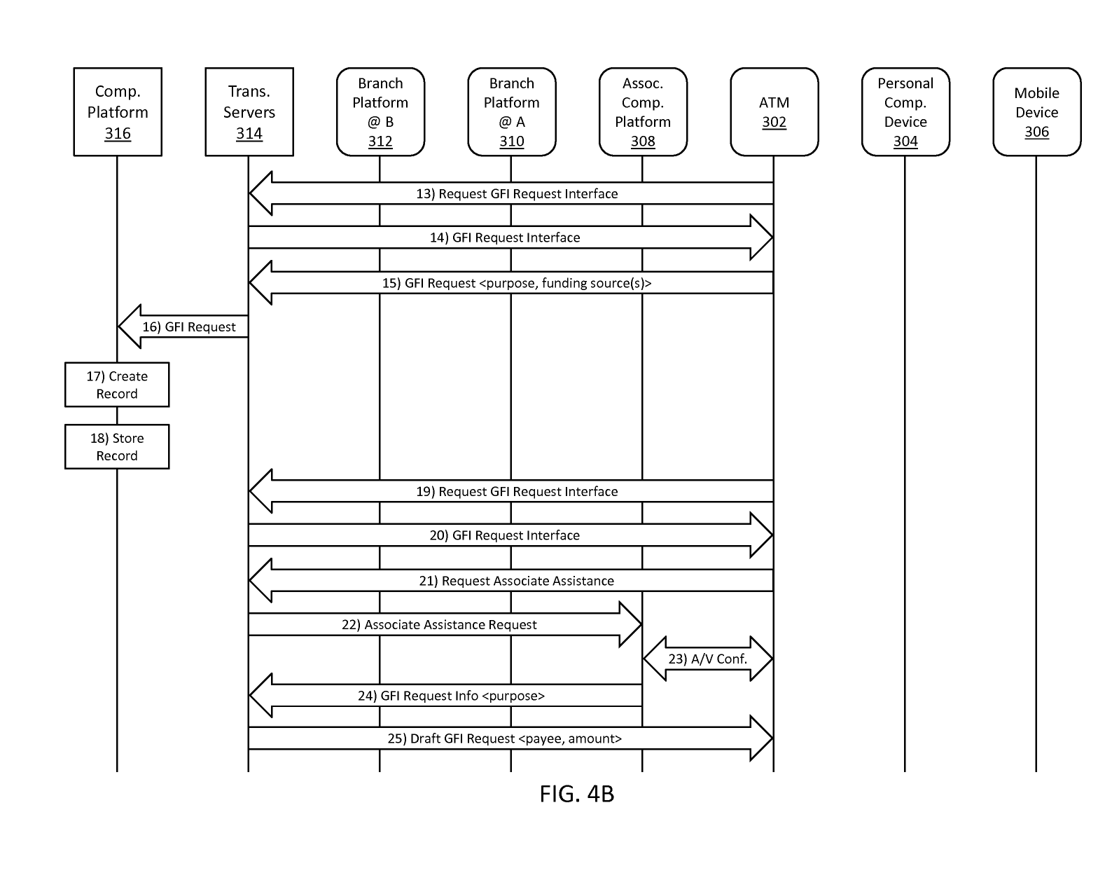

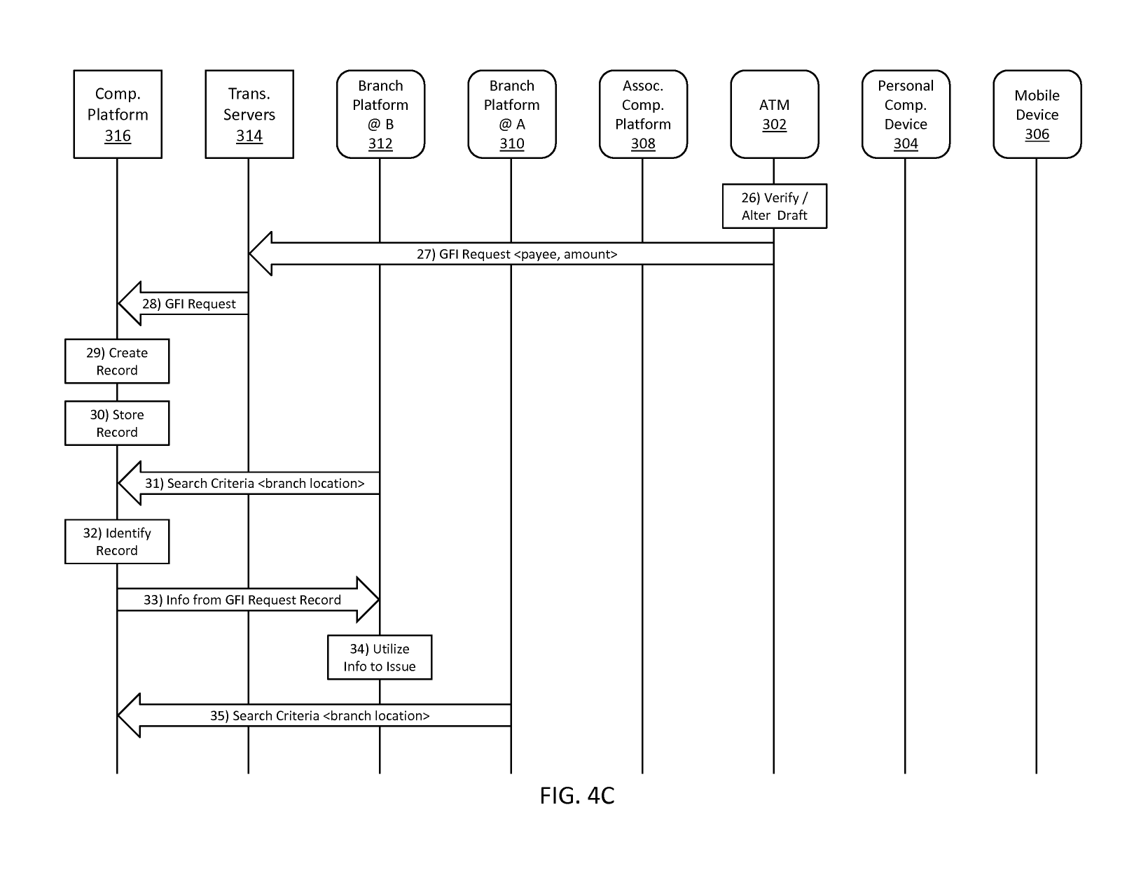

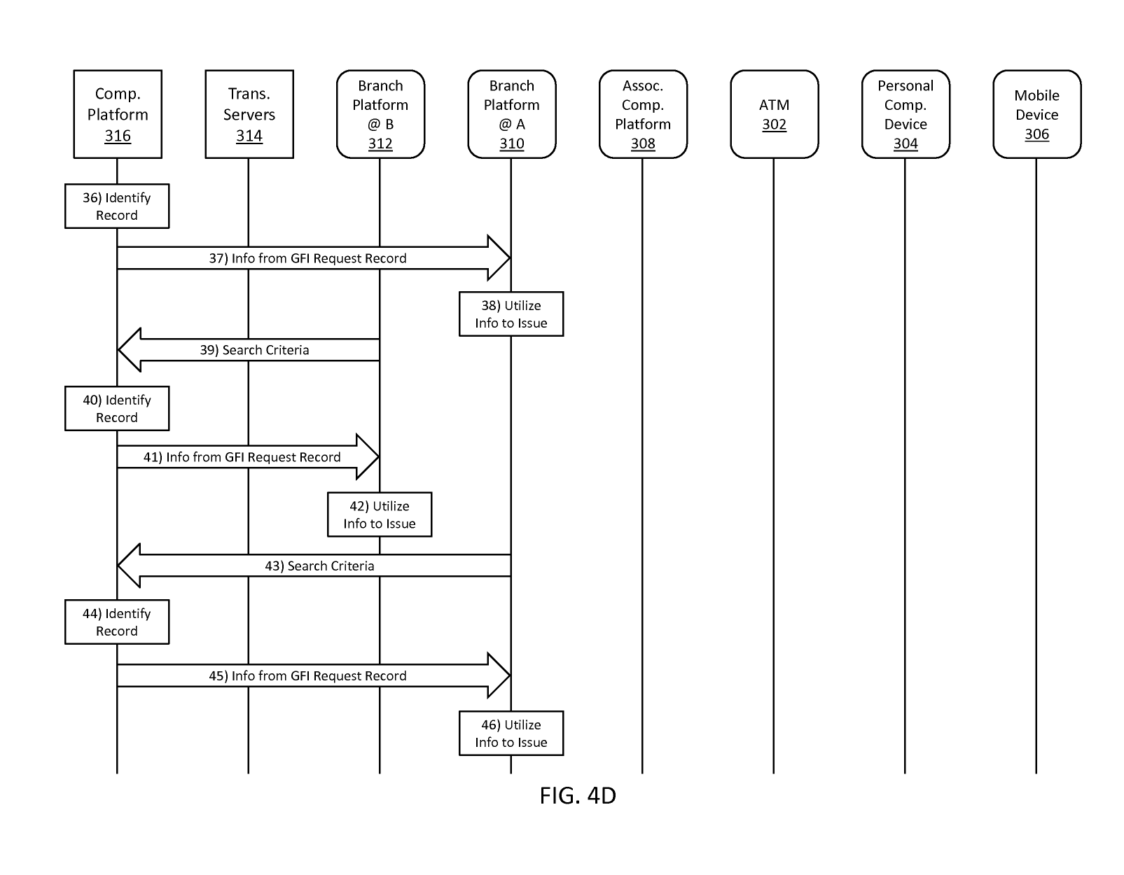

FIGS. 4A, 4B, 4C, and 4D depict an illustrative event sequence for providing self-service guaranteed financial instruments in accordance with one or more example embodiments. Referring to FIG. 4A, at step 1, one or more of transaction servers 314 may receive a request for a guaranteed financial instrument request interface from personal computing device 304. For example, personal computing device 304 may be executing a web browser application that presents a website associated with a financial institution, and a user of personal computing device 304 may invoke an option of the website for requesting a guaranteed financial instrument from the financial institution. At step 2, one or more of transaction servers 314 may communicate an interface for requesting a guaranteed financial instrument to personal computing device 304. For example, a webserver hosting the website associated with the financial institution may generate an interface for requesting a guaranteed financial instrument from the financial institution, and communicate the interface for requesting a guaranteed financial instrument to personal computing device 304. At step 3, one or more of transaction servers 314 may receive a request for a guaranteed financial instrument from personal computing device 304. For example, the user of personal computing device 304 may have utilized the interface for requesting a guaranteed financial instrument from the financial institution to generate a request for a guaranteed financial instrument from the financial institution, and personal computing device 304 may communicate the request for the guaranteed financial instrument to one or more of transaction servers 314. At step 4, one or more of transaction servers 314 may communicate the request for the guaranteed financial instrument to computing platform 316.

In some embodiments, the request for the financial instrument guaranteed by the financial institution may include information indicating a payee for the financial instrument guaranteed by the financial institution and/or a payment amount for the financial instrument guaranteed by the financial institution. For example, the user of personal computing device 304 may have utilized the interface for requesting a guaranteed financial instrument from the financial institution to specify a payee for the financial instrument guaranteed by the financial institution and/or a payment amount for the financial instrument guaranteed by the financial institution, and a webserver hosting the website associated with the financial institution (e.g., one or more of transaction servers 314) may communicate the information indicating the payee for the financial instrument guaranteed by the financial institution and the payment amount for the financial instrument guaranteed by the financial institution to computing platform 316 (e.g., as part of the request for the guaranteed financial instrument).

In some embodiments, the request for the financial instrument guaranteed by the financial institution may include information for identifying a branch location affiliated with the financial institution for picking up the financial instrument guaranteed by the financial institution. For example, the user of personal computing device 304 may have utilized the interface for requesting a guaranteed financial instrument from the financial institution to specify a branch location affiliated with the financial institution (e.g., location B) for picking up the financial instrument guaranteed by the financial institution, and a webserver hosting the website associated with the financial institution (e.g., one or more of transaction servers 314) may communicate the information identifying the branch location affiliated with the financial institution for picking up the financial instrument guaranteed by the financial institution to computing platform 316 (e.g., as part of the request for the guaranteed financial instrument).

At step 5, computing platform 316 may create a record for the request for the financial instrument guaranteed by the financial institution. For example, computing platform 316 may create a record comprising information associated with the request for the financial instrument guaranteed by the financial institution (e.g., the information indicating the payee for the financial instrument guaranteed by the financial institution, the information indicating the payment amount for the financial instrument guaranteed by the financial institution, and/or the information identifying the branch location affiliated with the financial institution for picking up the financial instrument guaranteed by the financial institution) received from personal computing device 304 via one or more of transaction servers 314. At step 6, computing platform 316 may store the record for the request for the financial instrument guaranteed by the financial institution in a database comprising a plurality of records for requests for financial instruments guaranteed by the financial institution.

At step 7, one or more of transaction servers 314 may receive a request for a guaranteed financial instrument request interface from mobile device 306. For example, mobile device 306 may be executing a mobile device application associated with a financial institution, and a user of mobile device 306 may invoke an option of the mobile device application associated with the financial institution for requesting a guaranteed financial instrument from the financial institution. At step 8, one or more of transaction servers 314 may communicate an interface for requesting a guaranteed financial instrument from the financial institution to mobile device 306. For example, a server in communication with mobile device 306 may generate an interface for requesting a guaranteed financial instrument from the financial institution, and communicate the interface for requesting a guaranteed financial instrument to mobile device 306. At step 9, one or more of transaction servers 314 may receive a request for a guaranteed financial instrument from mobile device 306. For example, the user of mobile device 306 may have utilized the interface for requesting a guaranteed financial instrument from the financial institution to generate a request for a guaranteed financial instrument from the financial institution, and mobile device 306 may communicate the request for the guaranteed financial instrument to one or more of transaction servers 314. At step 10, one or more of transaction servers 314 may communicate the request for the guaranteed financial instrument to computing platform 316.

In some embodiments, the request for the financial instrument guaranteed by the financial institution may include information indicating a purpose for the financial instrument guaranteed by the financial institution. For example, the user of mobile device 306 may have utilized the interface for requesting a guaranteed financial instrument from the financial institution to specify that the purpose for the financial instrument guaranteed by the financial institution is to close an account of the financial institution, and a server in communication with mobile device 306 (e.g., one or more of transaction servers 314) may communicate the information indicating the purpose for the financial instrument guaranteed by the financial institution to computing platform 316 (e.g., as part of the request for the guaranteed financial instrument). Computing platform 316 may utilize the information indicating the purpose for the financial instrument guaranteed by the financial institution to determine a payee for the financial instrument guaranteed by the financial institution and/or a payment amount for the financial instrument guaranteed by the financial institution. For example, computing platform 316 may determine a payment amount for the financial instrument guaranteed by the financial institution based on a current balance of the account being closed.

In some embodiments, the request for the financial instrument guaranteed by the financial institution may include information for identifying a branch location affiliated with the financial institution for picking up the financial instrument guaranteed by the financial institution. For example, the user of mobile device 306 may have utilized the interface for requesting a guaranteed financial instrument from the financial institution to specify a branch location affiliated with the financial institution (e.g., location A) for picking up the financial instrument guaranteed by the financial institution, and a server in communication with mobile device 306 may communicate the information identifying the branch location affiliated with the financial institution for picking up the financial instrument guaranteed by the financial institution to computing platform 316 (e.g., as part of the request for the guaranteed financial instrument).

At step 11, computing platform 316 may create a record for the request for the financial instrument guaranteed by the financial institution. For example, computing platform 316 may create a record comprising information associated with the request for the financial instrument guaranteed by the financial institution (e.g., the information indicating the purpose for the financial instrument guaranteed by the financial institution, the information indicating the payee for the financial instrument guaranteed by the financial institution, the information indicating the payment amount for the financial instrument guaranteed by the financial institution, and/or the information identifying the branch location affiliated with the financial institution for picking up the financial instrument guaranteed by the financial institution). At step 12, computing platform 316 may store the record for the request for the financial instrument guaranteed by the financial institution in a database comprising a plurality of records for requests for financial instruments guaranteed by the financial institution (e.g., the record for the request for the financial instrument guaranteed by the financial institution created in step 5 above).

Referring to FIG. 4B, at step 13, one or more of transaction servers 314 may receive a request for a guaranteed financial instrument request interface from ATM 302. For example, ATM 302 may be configured to support requesting guaranteed financial instruments from a financial institution associated with ATM 302, and a user of ATM 302 may invoke an option provided by ATM 302 for requesting a guaranteed financial instrument from the financial institution. At step 14, one or more of transaction servers 314 may communicate an interface for requesting a guaranteed financial instrument from the financial institution to ATM 302. For example, a server in communication with ATM 302 may generate an interface for requesting a guaranteed financial instrument from the financial institution, and communicate the interface for requesting a guaranteed financial instrument to ATM 302. At step 15, one or more of transaction servers 314 may receive a request for a guaranteed financial instrument from ATM 302. For example, the user of ATM 302 may have utilized the interface for requesting a guaranteed financial instrument from the financial institution to generate a request for a guaranteed financial instrument from the financial institution, and ATM 302 may communicate the request for the guaranteed financial instrument to one or more of transaction servers 314. At step 16, one or more of transaction servers 314 may communicate the request for the guaranteed financial instrument to computing platform 316.

The request for the financial instrument guaranteed by the financial institution may include information indicating a purpose for the financial instrument guaranteed by the financial institution. For example, the user of ATM 302 may have input, via the ATM, (e.g., utilizing the interface for requesting a guaranteed financial instrument from the financial institution) information specifying that the purpose for the financial instrument guaranteed by the financial institution is to pay a debt obligation owed to a lending entity associated with the financial institution, and a server in communication with ATM 302 (e.g., one or more of transaction servers 314) may communicate the information indicating the purpose for the financial instrument guaranteed by the financial institution to computing platform 316 (e.g., as part of the request for the guaranteed financial instrument). Computing platform 316 may utilize the information indicating the purpose for the financial instrument guaranteed by the financial institution to determine a payee for the financial instrument guaranteed by the financial institution and/or a payment amount for the financial instrument guaranteed by the financial institution. For example, computing platform 316 may determine a payee for the financial instrument guaranteed by the financial institution to be the lending entity associated with the financial institution and/or a payment amount for the financial instrument guaranteed by the financial institution to be an amount associated with the debt obligation owed to the lending entity associated with the financial institution.

In some embodiments, the request for the financial instrument guaranteed by the financial institution may include information identifying one or more funding sources for the request for the financial instrument guaranteed by the financial institution. For example, the information identifying one or more funding sources for the request for the financial instrument guaranteed by the financial institution may identify funds deposited with the financial institution (e.g., in an account of the financial institution associated with the user of ATM 302), a wire transfer to the financial institution (e.g., a past or future wire transfer to the financial institution by or on behalf of the user of ATM 302), and/or a cash deposit with the financial institution (e.g., a contemporaneous deposit of cash made by the user of ATM 302).

At step 17, computing platform 316 may create a record for the request for the financial instrument guaranteed by the financial institution. For example, computing platform 316 may create a record comprising information associated with the request for the financial instrument guaranteed by the financial institution (e.g., the information indicating the purpose for the financial instrument guaranteed by the financial institution, the information indicating the payee for the financial instrument guaranteed by the financial institution, the information indicating the payment amount for the financial instrument guaranteed by the financial institution, and/or the information identifying one or more funding sources for the request for the financial instrument guaranteed by the financial institution). At step 18, computing platform 316 may store the record for the request for the financial instrument guaranteed by the financial institution in a database comprising a plurality of records for requests for financial instruments guaranteed by the financial institution (e.g., the records for the requests for the financial instruments guaranteed by the financial institution created in steps 5 and 11 above).

At step 19, one or more of transaction servers 314 may receive a request for a guaranteed financial instrument request interface from ATM 302. For example, ATM 302 may be configured to support requesting guaranteed financial instruments from a financial institution associated with ATM 302, and a user of ATM 302 may invoke an option provided by ATM 302 for requesting a guaranteed financial instrument from the financial institution. At step 20, one or more of transaction servers 314 may communicate an interface for requesting a guaranteed financial instrument from the financial institution to ATM 302. For example, a server in communication with ATM 302 may generate an interface for requesting a guaranteed financial instrument from the financial institution, and communicate the interface for requesting a guaranteed financial instrument to ATM 302. At step 21, one or more of transaction servers 314 may receive a request for associate assistance from ATM 302. For example, the interface for requesting a guaranteed financial instrument from the financial institution may include an option for requesting associate assistance, and the user of ATM 302 may invoke the option for requesting associate assistance (e.g., the user may have a question regarding the interface for requesting a guaranteed financial instrument from the financial institution and/or the user may be having difficulty using the interface for requesting a guaranteed financial instrument from the financial institution).

At step 22, one or more of transaction servers 314 may communicate the request for associate assistance to an associate computing platform. For example, one or more of transaction servers 314 may communicate the request for associate assistance to associate computing platform 308. At step 23, an audio/video conference session may be established between associate computing platform 308 and ATM 302. The user of ATM 302 may utilize the audio/video conference session to communicate with an associate of the financial institution utilizing associate computing platform 308. For example, the user of ATM 302 may utilize the audio/video conference session to communicate information regarding a request for a guaranteed financial instrument to an associate of the financial institution utilizing associate computing platform 308. At step 24, one or more of transaction servers 314 may receive a request for a guaranteed financial instrument from associate computing platform 308. For example, the associate of the financial institution utilizing associate computing platform 308 may have utilized the information regarding the request for the guaranteed financial instrument communicated by the user of ATM 302 via the audio/video conference session to generate a request for a guaranteed financial instrument from the financial institution, and associate computing platform 308 may communicate the request for the guaranteed financial instrument to one or more of transaction servers 314.

The request for the financial instrument guaranteed by the financial institution may include information indicating a purpose for the financial instrument guaranteed by the financial institution. For example, the user of ATM 302 may have indicated via the audio/video conference session that the purpose for the financial instrument guaranteed by the financial institution is to exchange a non-guaranteed financial instrument associated with the financial institution for the financial instrument guaranteed by the financial institution, and the associate of the financial institution may have utilized associate computing platform 308 to input the purpose for the financial instrument guaranteed by the financial institution (e.g., information associated with the exchange of the non-guaranteed financial instrument associated with the financial institution for the financial instrument guaranteed by the financial institution). One or more of transaction servers 314 may utilize the information indicating the purpose for the financial instrument guaranteed by the financial institution to determine a payee for the financial instrument guaranteed by the financial institution and/or a payment amount for the financial instrument guaranteed by the financial institution. For example, one or more of transaction servers 314 may determine that the payee for the financial instrument guaranteed by the financial institution is a payee indicated by the non-guaranteed financial instrument associated with the financial institution, and/or that the payment amount for the financial instrument guaranteed by the financial institution is an amount specified by the non-guaranteed financial instrument associated with the financial institution. At step 25, one or more of transaction servers 314 may communicate a draft request for the guaranteed financial instrument to ATM 302. Referring to FIG. 4C, at step 26, ATM 302 may display the draft request for the guaranteed financial instrument, and the user of ATM 302 may verify and/or alter the draft request for the guaranteed financial instrument. At step 27, ATM 302 may communicate the request for the guaranteed financial instrument to one or more of transaction servers 314, which, at step 28, may communicate the request for the guaranteed financial instrument to computing platform 316.

At step 29, computing platform 316 may create a record for the request for the financial instrument guaranteed by the financial institution. For example, computing platform 316 may create a record comprising information associated with the request for the financial instrument guaranteed by the financial institution (e.g., the information indicating the purpose for the financial instrument guaranteed by the financial institution, the information indicating the payee for the financial instrument guaranteed by the financial institution, and/or the information indicating the payment amount for the financial instrument guaranteed by the financial institution). At step 30, computing platform 316 may store the record for the request for the financial instrument guaranteed by the financial institution in a database comprising a plurality of records for requests for financial instruments guaranteed by the financial institution (e.g., the records for the requests for the financial instruments guaranteed by the financial institution created in steps 5, 11, and 17 above).

At step 31, computing platform 316 may receive search criteria specifying one or more aspects of a record for a request for a financial instrument guaranteed by the financial institution from branch computing platform 312. For example, the user of personal computing device 304 (discussed above with respect to steps 1-6) may have presented themselves at a branch location of the financial institution that utilizes branch computing platform 312 (e.g., location B). In some embodiments, the search criteria specifying one or more aspects of the record for the request for the financial instrument guaranteed by the financial institution may include information for identifying the branch location of the financial institution. At step 32, computing platform 316 may utilize the search criteria specifying one or more aspects of the record for the request for the financial instrument guaranteed by the financial institution to identify, from amongst a plurality of records for requests for financial instruments guaranteed by the financial institution, the record for the request for the financial instrument guaranteed by the financial institution. For example, computing platform 316 may utilize the information for identifying the branch location of the financial institution to identify the record for the request for the financial instrument guaranteed by the financial institution that was created in step 5 above from amongst the records for the requests for the financial instruments guaranteed by the financial institution created in steps 5, 11, 17, and 29 above.

At step 33, computing platform 316 may communicate information stored in the record for the request for the financial instrument guaranteed by the financial institution to branch computing platform 312. For example, computing platform 316 may communicate the information indicating the payee for the financial instrument guaranteed by the financial institution and/or the information indicating the payment amount for the financial instrument guaranteed by the financial institution to branch computing platform 312. At step 34, branch computing platform 312 may utilize the information received from computing platform 316 to issue the financial instrument guaranteed by the financial institution to the user of personal computing device 304 (discussed above with respect to steps 1-6). The financial instrument guaranteed by the financial institution may be a cashier's check, a banker's check, a certified check, and/or an official check.

At step 35, computing platform 316 may receive search criteria specifying one or more aspects of a record for a request for a financial instrument guaranteed by the financial institution from branch computing platform 310. For example, the user of mobile device 306 (discussed above with respect to steps 7-12) may have presented themselves at a branch location of the financial institution that utilizes branch computing platform 310 (e.g., location A). The search criteria specifying one or more aspects of the record for the request for the financial instrument guaranteed by the financial institution may include information for identifying the branch location of the financial institution. Referring to FIG. 4D, at step 36, computing platform 316 may utilize the search criteria specifying one or more aspects of the record for the request for the financial instrument guaranteed by the financial institution to identify, from amongst a plurality of records for requests for financial instruments guaranteed by the financial institution, the record for the request for the financial instrument guaranteed by the financial institution. For example, computing platform 316 may utilize the information for identifying the branch location of the financial institution to identify the record for the request for the financial instrument guaranteed by the financial institution that was created in step 11 above from amongst the records for the requests for the financial instruments guaranteed by the financial institution created in steps 5, 11, 17, and 29 above.

At step 37, computing platform 316 may communicate information stored in the record for the request for the financial instrument guaranteed by the financial institution to branch computing platform 310. For example, computing platform 316 may communicate the information indicating the payee for the financial instrument guaranteed by the financial institution and/or the information indicating the payment amount for the financial instrument guaranteed by the financial institution to branch computing platform 310. At step 38, branch computing platform 310 may utilize the information received from computing platform 316 to issue the financial instrument guaranteed by the financial institution to the user of mobile device 306 (discussed above with respect to steps 7-12).

At step 39, computing platform 316 may receive search criteria specifying one or more aspects of a record for a request for a financial instrument guaranteed by the financial institution from branch computing platform 312. For example, the user of ATM 302 (discussed above with respect to steps 13-18) may have presented themselves at a branch location of the financial institution that utilizes branch computing platform 312 (e.g., location B). At step 40, computing platform 316 may utilize the search criteria to identify, the record for the request for the financial instrument guaranteed by the financial institution that was created in step 17 above from amongst the records for the requests for the financial instruments guaranteed by the financial institution created in steps 5, 11, 17, and 29 above. At step 41, computing platform 316 may communicate information stored in the record for the request for the financial instrument guaranteed by the financial institution to branch computing platform 312. For example, computing platform 316 may communicate the information indicating the payee for the financial instrument guaranteed by the financial institution and/or the information indicating the payment amount for the financial instrument guaranteed by the financial institution to branch computing platform 312. At step 42, branch computing platform 312 may utilize the information received from computing platform 316 to issue the financial instrument guaranteed by the financial institution to the user of ATM 302 (discussed above with respect to steps 13-18).

At step 43, computing platform 316 may receive search criteria specifying one or more aspects of a record for a request for a financial instrument guaranteed by the financial institution from branch computing platform 310. For example, the user of ATM 302 (discussed above with respect to steps 19-30) may have presented themselves at a branch location of the financial institution that utilizes branch computing platform 310 (e.g., location A). At step 44, computing platform 316 may utilize the search criteria to identify, the record for the request for the financial instrument guaranteed by the financial institution that was created in step 29 above from amongst the records for the requests for the financial instruments guaranteed by the financial institution created in steps 5, 11, 17, and 29 above. At step 45, computing platform 316 may communicate information stored in the record for the request for the financial instrument guaranteed by the financial institution to branch computing platform 310. For example, computing platform 316 may communicate the information indicating the payee for the financial instrument guaranteed by the financial institution and/or the information indicating the payment amount for the financial instrument guaranteed by the financial institution to branch computing platform 310. At step 46, branch computing platform 310 may utilize the information received from computing platform 316 to issue the financial instrument guaranteed by the financial institution to the user of ATM 302 (discussed above with respect to steps 19-30).

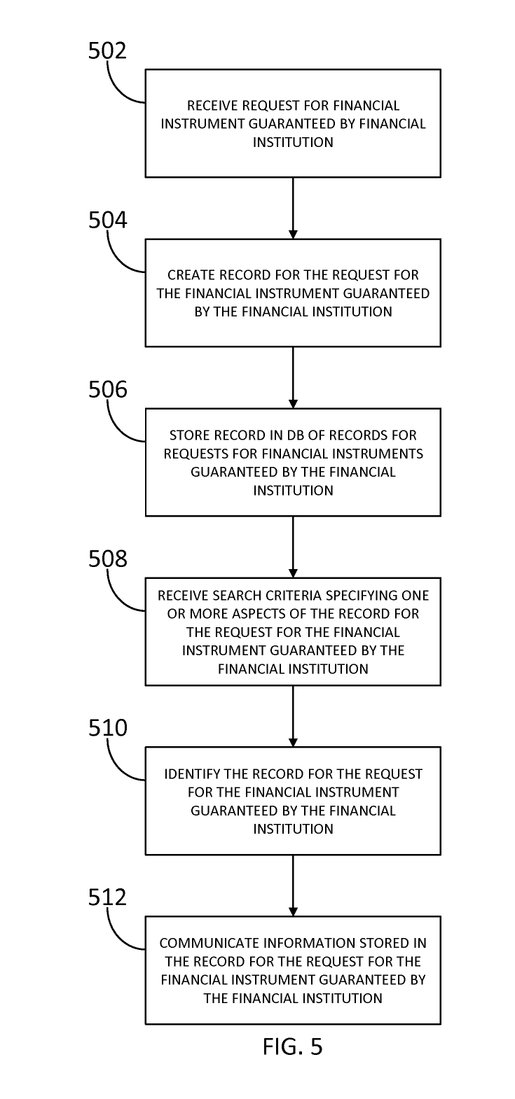

FIG. 5 depicts an illustrative method for providing self-service guaranteed financial instruments in accordance with one or more example embodiments. Referring to FIG. 5, at step 502, a request for a financial instrument guaranteed by a financial institution may be received from a user device. For example, computing platform 316 may receive a request for a financial instrument guaranteed by a financial institution from personal computing device 304 via one or more of transaction servers 314. At step 504, a record may be created for the request for the financial instrument guaranteed by the financial institution. For example, computing platform 316 may create a record for the request for the financial instrument guaranteed by the financial institution received from personal computing device 304. At step 506, the record for the request for the financial instrument guaranteed by the financial institution may be stored in a database comprising a plurality of records for requests for financial instruments guaranteed by the financial institution. For example, computing platform 316 may store the record for the request for the financial instrument guaranteed by the financial institution received from personal computing device 304 in a database comprising a plurality of records for requests for financial instruments guaranteed by the financial institution.

At step 508, search criteria specifying one or more aspects of the record for the request for the financial instrument guaranteed by the financial institution may be received from a computing device associated with the financial institution. For example, search criteria specifying one or more aspects of the record for the request for the financial instrument guaranteed by the financial institution received from personal computing device 304 may be received from branch computing platform 312. At step 510, the record for the request for the financial instrument guaranteed by the financial institution may be identified from amongst the plurality of records for requests for financial instruments guaranteed by the financial institution. For example, computing platform 316 may utilize the search criteria specifying the one or more aspects of the record for the request for the financial instrument guaranteed by the financial institution received from personal computing device 304 from amongst the plurality of records for requests for financial instruments guaranteed by the financial institution in the database. At step 512, information stored in the record for the request for the financial instrument guaranteed by the financial institution may be communicated to the computing device associated with the financial institution. For example, computing platform 316 may communicate information stored in the record for the request for the financial instrument guaranteed by the financial institution received from personal computing device 304 (e.g., information indicating the payee for the financial instrument guaranteed by the financial institution and/or information indicating the payment amount for the financial instrument guaranteed by the financial institution) to branch computing platform 312.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A method, comprising:
at a computing platform comprising at least one processor, a memory, and a communication interface:
receiving, via the communication interface and from a user device, a request for a financial instrument guaranteed by a financial institution;
creating, by the at least one processor, a record for the request for the financial instrument guaranteed by the financial institution;
storing, in a database stored in the memory, the record for the request for the financial instrument guaranteed by the financial institution, wherein the database comprises a plurality of records for requests for financial instruments guaranteed by the financial institution;
receiving, via the communication interface and from a computing device associated with the financial institution, search criteria specifying one or more aspects of the record for the request for the financial instrument guaranteed by the financial institution;
utilizing, by the at least one processor, the search criteria specifying one or more aspects of the record for the request for the financial instrument guaranteed by the financial institution to identify, from amongst the plurality of records for requests for financial instruments guaranteed by the financial institution, the record for the request for the financial instrument guaranteed by the financial institution; and
communicating, via the communication interface and to the computing device associated with the financial institution, information stored in the record for the request for the financial instrument guaranteed by the financial institution.

2. The method of claim 1, wherein the request for the financial instrument guaranteed by the financial institution comprises information indicating a payee for the financial instrument guaranteed by the financial institution and a payment amount for the financial instrument guaranteed by the financial institution.

3. The method of claim 2, wherein the user device comprises a personal computing device executing a web browser application that presents a website associated with the financial institution, and wherein receiving the request for the financial instrument guaranteed by the financial institution comprises receiving the information indicating the payee for the financial instrument guaranteed by the financial institution and the payment amount for the financial instrument guaranteed by the financial institution via a webserver hosting the website associated with the financial institution.

4. The method of claim 2, wherein the user device comprises a mobile device executing a mobile device application associated with the financial institution, and wherein receiving the request for the financial instrument guaranteed by the financial institution comprises receiving the information indicating the payee for the financial instrument guaranteed by the financial institution and the payment amount for the financial instrument guaranteed by the financial institution via a server in communication with the mobile device executing the mobile device application associated with the financial institution.

5. The method of claim 2, wherein the user device comprises an automated teller machine (ATM), and wherein receiving the request for the financial instrument guaranteed by the financial institution comprises receiving the information indicating the payee for the financial instrument guaranteed by the financial institution and the payment amount for the financial instrument guaranteed by the financial institution via a server in communication with the ATM.

6. The method of claim 5, wherein at least a portion of the information indicating the payee for the financial instrument guaranteed by the financial institution and the payment amount for the financial instrument guaranteed by the financial institution is input, via the ATM, by an individual requesting the financial instrument guaranteed by the financial institution.

7. The method of claim 5, wherein at least a portion of the information indicating the payee for the financial instrument guaranteed by the financial institution and the payment amount for the financial instrument guaranteed by the financial institution is input by an associate of the financial institution communicating, via the ATM, with an individual requesting the financial instrument guaranteed by the financial institution.

8. The method of claim 7, wherein the at least a portion of the information indicating the payee for the financial instrument guaranteed by the financial institution and the payment amount for the financial instrument guaranteed by the financial institution is verified, via the ATM, by the individual requesting the financial instrument guaranteed by the financial institution.

9. The method of claim 7, wherein the at least a portion of the information indicating the payee for the financial instrument guaranteed by the financial institution and the payment amount for the financial instrument guaranteed by the financial institution is communicated to the associate of the financial institution by the individual requesting the financial instrument guaranteed by the financial institution via a video conference session supported by the ATM.

10. The method of claim 1, wherein at least one record of the plurality of records for requests for financial instruments guaranteed by the financial institution indicates one or more funding sources for a request for a financial instrument guaranteed by the financial institution corresponding to the at least one record.

11. The method of claim 1, comprising:
receiving information identifying one or more funding sources for the request for the financial instrument guaranteed by the financial institution; and
identifying, in the record for the request for the financial instrument guaranteed by the financial institution, the one or more funding sources for the request for the financial instrument guaranteed by the financial institution.

12. The method of claim 11, wherein the one or more funding sources for the request for the financial instrument guaranteed by the financial institution comprise at least one of funds deposited with the financial institution, a wire transfer to the financial institution, or a cash deposit with the financial institution.

13. The method of claim 1, wherein the request for the financial instrument guaranteed by the financial institution comprises information indicating a purpose for the financial instrument guaranteed by the financial institution, the method comprising utilizing the information indicating the purpose for the financial instrument guaranteed by the financial institution to determine at least one of a payee for the financial instrument guaranteed by the financial institution or a payment amount for the financial instrument guaranteed by the financial institution.

14. The method of claim 13, wherein the information indicating the purpose for the financial instrument guaranteed by the financial institution indicates that the purpose for the financial instrument guaranteed by the financial institution is to close an account of the financial institution, and wherein utilizing the information indicating the purpose for the financial instrument guaranteed by the financial institution to determine at least one of a payee for the financial instrument guaranteed by the financial institution or a payment amount for the financial instrument guaranteed by the financial institution comprises determining the payment amount for the financial instrument guaranteed by the financial institution based on a current balance of the account of the financial institution.

15. The method of claim 13, wherein the information indicating the purpose for the financial instrument guaranteed by the financial institution indicates that the purpose for the financial instrument guaranteed by the financial institution is to pay a debt obligation owed to a lending entity associated with the financial institution, and wherein utilizing the information indicating the purpose for the financial instrument guaranteed by the financial institution to determine at least one of a payee for the financial instrument guaranteed by the financial institution or a payment amount for the financial instrument guaranteed by the financial institution comprises determining at least one of that the payee for the financial instrument guaranteed by the financial institution is the lending entity associated with the financial institution or that the payment amount for the financial instrument guaranteed by the financial institution is an amount associated with the debt obligation owed to the lending entity associated with the financial institution.

16. The method of claim 13, wherein the information indicating the purpose for the financial instrument guaranteed by the financial institution indicates that the purpose for the financial instrument guaranteed by the financial institution is to exchange a non-guaranteed financial instrument associated with the financial institution for the financial instrument guaranteed by the financial institution, and wherein utilizing the information indicating the purpose for the financial instrument guaranteed by the financial institution to determine at least one of a payee for the financial instrument guaranteed by the financial institution or a payment amount for the financial instrument guaranteed by the financial institution comprises determining at least one of that the payee for the financial instrument guaranteed by the financial institution is a payee indicated by the non-guaranteed financial instrument associated with the financial institution or that the payment amount for the financial instrument guaranteed by the financial institution is an amount specified by the non-guaranteed financial instrument associated with the financial institution.

17. The method of claim 1, wherein the request for the financial instrument guaranteed by the financial institution comprises information for identifying a branch location affiliated with the financial institution for picking up the financial instrument guaranteed by the financial institution, and wherein the search criteria specifying one or more aspects of the record for the request for the financial instrument guaranteed by the financial institution comprises at least a portion of the information for identifying a branch location affiliated with the financial institution for picking up the financial instrument guaranteed by the financial institution.

18. The method of claim 1, wherein the financial instrument guaranteed by the financial institution comprises at least one of a cashier's check, a banker's check, a certified check, or an official check.

19. An apparatus, comprising:
at least one processor; and
a memory storing instructions that when executed by the at least one processor cause the apparatus to:
receive, from a user device, a request for a financial instrument guaranteed by a financial institution, wherein the request for the financial instrument guaranteed by the financial institution comprises information indicating a purpose for the financial instrument guaranteed by the financial institution;
utilize the information indicating the purpose for the financial instrument guaranteed by the financial institution to determine at least one of a payee for the financial instrument guaranteed by the financial institution or a payment amount for the financial instrument guaranteed by the financial institution;
create a record for the request for the financial instrument guaranteed by the financial institution, wherein the record for the request for the financial instrument guaranteed by the financial institution comprises the at least one of the payee for the financial instrument guaranteed by the financial institution or the payment amount for the financial instrument guaranteed by the financial institution;
store, in a database, the record for the request for the financial instrument guaranteed by the financial institution, wherein the database comprises a plurality of records for requests for financial instruments guaranteed by the financial institution;
receive, from a computing device associated with the financial institution, search criteria specifying one or more aspects of the record for the request for the financial instrument guaranteed by the financial institution;
utilize the search criteria specifying one or more aspects of the record for the request for the financial instrument guaranteed by the financial institution to identify, from amongst the plurality of records for requests for financial instruments guaranteed by the financial institution, the record for the request for the financial instrument guaranteed by the financial institution; and
communicate, to the computing device associated with the financial institution, information stored in the record for the request for the financial instrument guaranteed by the financial institution, wherein the information stored in the record for the request for the financial instrument guaranteed by the financial institution comprises the at least one of the payee for the financial instrument guaranteed by the financial institution or the payment amount for the financial instrument guaranteed by the financial institution.

20. One or more non-transitory computer-readable media having instructions stored thereon, that when executed by one or more computers, cause the one or more computers to:
receive, from a user device, a request for a financial instrument guaranteed by a financial institution, wherein the request for the financial instrument guaranteed by the financial institution comprises information indicating a payee for the financial instrument guaranteed by the financial institution and a payment amount for the financial instrument guaranteed by the financial institution;
create a record for the request for the financial instrument guaranteed by the financial institution;
store, in a database, the record for the request for the financial instrument guaranteed by the financial institution, wherein the database comprises a plurality of records for requests for financial instruments guaranteed by the financial institution;
receive, from a computing device associated with the financial institution, search criteria specifying one or more aspects of the record for the request for the financial instrument guaranteed by the financial institution;
utilize the search criteria specifying one or more aspects of the record for the request for the financial instrument guaranteed by the financial institution to identify, from amongst the plurality of records for requests for financial instruments guaranteed by the financial institution, the record for the request for the financial instrument guaranteed by the financial institution; and
communicate, to the computing device associated with the financial institution, information stored in the record for the request for the financial instrument guaranteed by the financial institution.
